(19) United States
(12) Patent Application Publication
(10) Pub. No.: US 2019/0236283 A1
(43) Pub. Date: Aug. 1, 2019

(54) DATA ANALYSIS IN STREAMING DATA

(71) Applicant: International Business Machines Corporation, Armonk, NY (US)

(72) Inventors: David M. Koster, Rochester, MN (US); Alexander Pogue, Rochester, MN (US); Alexander Cook, London (GB); Christopher R. Sabotta, Rochester, MN (US)

(21) Appl. No.: 15/883,583

(22) Filed: Jan. 30, 2018

(51) Int. Cl. G06F 21/60; G06F 17/30; H04L 9/00

(52) U.S. Cl. CPC G06F 21/602; H04L 9/008; G06F 17/30153; G06F 17/30073

(57) ABSTRACT

A method for data analysis in streaming data includes receiving a stream of data, the stream of data including ordered compressed files. The method may also include partitioning the stream of data into portions of the ordered compressed files. The method may also include concurrently filtering each of the portions of ordered compressed files with a filter. The method may further include forward matching portions of the ordered compressed files downstream of the received stream of data.

### BACKGROUND

Homomorphic encryption enables computation on encrypted data without unencrypting the data. The results are also encrypted such that it's the same answer as if the unencrypted process were initiated, the computation was completed with a result, and the result was re-encrypted. Homomorphic compression similarly deals with the receipt of compressed data that is filtered without uncompressing the compressed data.

### SUMMARY

According to one embodiment of the present invention a method for data analysis in streaming data that includes receiving a stream of data, the stream of data including ordered compressed files. The method may also include partitioning the stream of data into portions of the ordered compressed files. The method may also include concurrently filtering each of the portions of ordered compressed files with a filter. The method may further include forward matching portions of the ordered compressed files downstream of the received stream of data.

According to a further embodiment of the present invention a data analysis system may include a data archive and a processor. In an example, the processor of the data analysis may receive a stream of data, with the stream of data including ordered compressed files. The processor may also cause the stream of data to be partitioned into portions of the ordered compressed files. The processor may also cause the portions of ordered compressed files to be concurrently filtered with a bloom filter. The processor may also cause matching portions of the ordered compressed files to be forwarded downstream of the received stream of data.

According to another embodiment of the present invention, a method of analyzing compressed streaming data may include creating the bloom filter by identifying a type of content within an archive to be filtered. The method may also include receiving a stream of data from the archive with the stream of data including ordered compressed files. The method may also include partitioning the stream of data into portions of the ordered compressed files. The method may also include concurrently filtering each of the portions of the ordered compressed files with the bloom filter. The method may also include forward matching portions of the ordered compressed files downstream of the received stream of data.

### BRIEF DESCRIPTION OF THE SEVERAL VIEWS OF THE DRAWINGS

The accompanying drawings illustrate various examples of the principles described herein and are a part of the specification. The illustrated examples do not limit the scope of the claims.

FIG. 1 is a flowchart showing a method for data analysis in stream data according to one example of principles described herein.

FIG. 2 is a block diagram of a data analysis system according to an example of the principles described herein.

FIG. 3 is a block diagram showing a computing device according to an example of the principles described herein.

Throughout the drawings, identical reference numbers designate similar, but not necessarily identical, elements.

### DETAILED DESCRIPTION

Homomorphic encryption and homomorphic compression allow for computation and filtering, respectively, of data. In some examples, this data may be maintained in an archive. However, homomorphic encryption and homomorphic compression are not used to render computation or filter compressed data in high speed processing contexts such as streaming data. Instead, in connection with streaming data, the overhead in processing resulting from the uncompressing of the data for computation or filtering is incurred.

This may result in a relatively higher processing cost than would be realized if homomorphic encryption and/or homomorphic compression were used to compute and/or filter streaming data. Additionally, streaming data is received by a computing device in an ordered fashion. Because the streaming data received by a computing device is both compressed and ordered, the computation and/or filtering may be slowed.

In the following description, for purposes of explanation, numerous specific details are set forth in order to provide a thorough understanding of the present systems and methods, it will be apparent, however, to one skilled in the art that the present apparatus, systems and methods may be practiced without these specific details. Reference in the specification to “an example” or similar language indicates that a particular feature, structure, or characteristic described in connection with that example is included as described, but may not be included in other examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

In the present specification and in the appended claims, the term “data” is meant to be understood as any computer readable information. In an example, the data may be presented in the form of a file either compressed or uncompressed or a tuple either compressed or uncompressed.

Even still further, as used in the present specification and in the appended claims, the term “a number of” or similar language is meant to be understood broadly as any positive number comprising 1 to infinity; zero not being a number, but the absence of a number.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

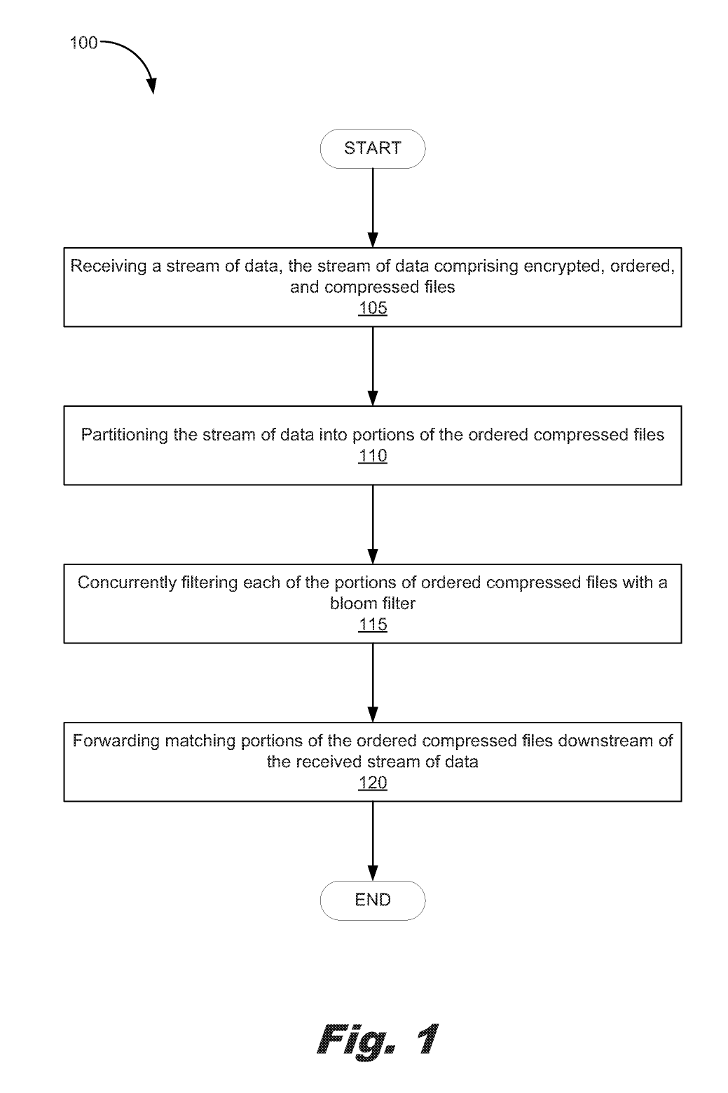

Turning now to the figures, FIG. 1 is a flowchart showing a method for data analysis in stream data according to one example of principles described herein. The method (100) may begin with receiving (105) a stream of data, the stream of data comprising encrypted, ordered, and compressed files. The stream of encrypted, compressed, and ordered data may include any data, file, or tuple that is compressed using any type of compression method. In an example, the data may have been compressed previous to receipt (105) using the GZIP compression method which is based on a lossless data compression method such as the DEFLATE method (a combination of a lossless data compression method (i.e., 117) and Huffman coding). Although GZIP is presented herein as an example, the present specification contemplates the use of other types of compression formats.

In an example, the files may be encrypted using any type of encrypted method. In an example, a series of encrypted and compressed files may include manifest containing metadata about the archive contents. In this example, the method (100) may further include forming a filter that is based on homomorphic encryption principles. In an example, homomorphic compression fingerprinting may be used that identifies potential filtered files. Fingerprinting is a technique for verifying whether two large data sets are equal. Examples include a “rolling” fingerprint process of Karp and Rabin and a cryptographic hash functions such as MD5.

The stream of encrypted, ordered, and compressed streaming data may be received at any computing device. Examples of computing devices may include servers, desktop computers, laptop computers, personal digital assistants (PDAs), mobile devices, smartphones, gaming systems, and tablets, among other computing devices. In an example, the encrypting and filtering processes may be completed using an application-specific integrated circuit (ASIC) or a field-programmable gate array (FPGA) on a computing device. In each of these examples, the computing device may include, at least, a processor to execute computer readable and executable program code to implement the processes and methods described herein.

The method (100) may continue with partitioning (110) the stream of data into portions of the ordered compressed files. This partitioning may be based on a logical separation of the stream of compressed and ordered files. As an example, if the compressed tiles included audio, the compressed data may indicate a number of “utterances” or sections of the audio that may indicate a location where the stream of data may be partitioned. For example, where the compressed audio data is compressed by the GZIP compression method, a file manifest may be addressed. In this example, the partitioning (110) process may include access and evaluation of that manifest. Where the file manifest indicates that multiple items exist within the compressed files, these may mark a location where the partitioning (110) may occur. If the data were uncompressed, the partitioning (110) may be made at any location. Lossless compression of data does not modify the entropy of the underlying data, as is the case of the DEFLATE compression process, which utilizes Huffman encoding. Since entropy is not changed between any two compressed tuples, they may be fingerprinted and differentiated between equally successfully whilst in their compressed form. Thus, in the present example, because of the entropy of data cannot be destroyed by changing the alignment boundaries of the data, serial operations, computations, and/or filtering may be parallelized in this manner.

The method (100) may continue with concurrently filtering (115) each of the portions of ordered compressed files with a filter. In an example, concurrently filtering (115) of each of the portions of ordered compressed files with a bloom filter. A bloom filter is a probabilistic data structure that is used to test whether data should be included as part of a set. In this example, the bloom filter may be created, prior to receiving (105) the stream of data comprising ordered compressed files. The creation of the bloom filter may be based on a type of data in an archive that the bloom filter is to be applied to. In this example, the archive includes compressed and encrypted data that is to be streamed to the computing device initiating the method (100) as described herein. The bloom filter may be used on the uncompressed data to determine the amount of entropy difference that defines a match versus a miss. By observing how positive matches are packed when uncompressed, the bloom filter can be changed to apply to compressed data. This may be done by, for example, implementing homomorphic fingerprinting techniques. Homomorphic fingerprinting is a form of compression that allows the Hamming distance between two data files to be estimated given the compressed form (the “fingerprint”) of each file. Some fingerprinting techniques perform relatively poorly when edits result in misaligned characters. However, n^{O(1/log log n)} bit fingerprints exist that are homomorphic with respect to both linear and rotation operations, i.e., given the fingerprint of a file (and not the file itself), the fingerprint of any cyclic rotation of the file (i.e., the above diagram commutes) may be constructed. Such fingerprints provide for a test to be performed in order to determine whether any two ordered and compressed files are within a small Hamming distance of being cyclic shifts of one another. Given a o(∈⁻²·polygon n) bit fingerprint of each of then rows of the adjacency matrix of a graph, the approximate size of every cut within a factor of (1+∈) with can be determined high probability. In an example, creating the bloom filter further includes determining this amount of entropy difference between at least one uncompressed file in the archive with a compressed version of the uncompressed file. In the present examples described herein fingerprinting may be turned into a filtering-type operation using the described bloom filters with noise added.

The method (100) may further include forward matching (120) portions of the ordered compressed files downstream of the received stream of data. In an example, forwarding matching portions of the ordered compressed files downstream of the received stream of data further includes uncompressing any matching portions of the ordered compressed files and applying an uncompressed data filter. This may be done so as to initially filter, in a relatively streaming basis, the data with the bloom filter. Because the bloom filters may occasionally provide false positives, a downstream uncompressed data filter may detect some portions of the ordered compressed files that should not actually belong to the set filtered by the bloom filter. In this way, the method (100) may relatively quickly filter compressed portions of streaming data finding all matching portions of data based on the bloom filter while filtering out further any false positives in a relatively slower fashion. Consequently, the present method (100) provides for filtering of streaming compressed data that consumes relatively less processing resources while also quickly running through the filtering process.

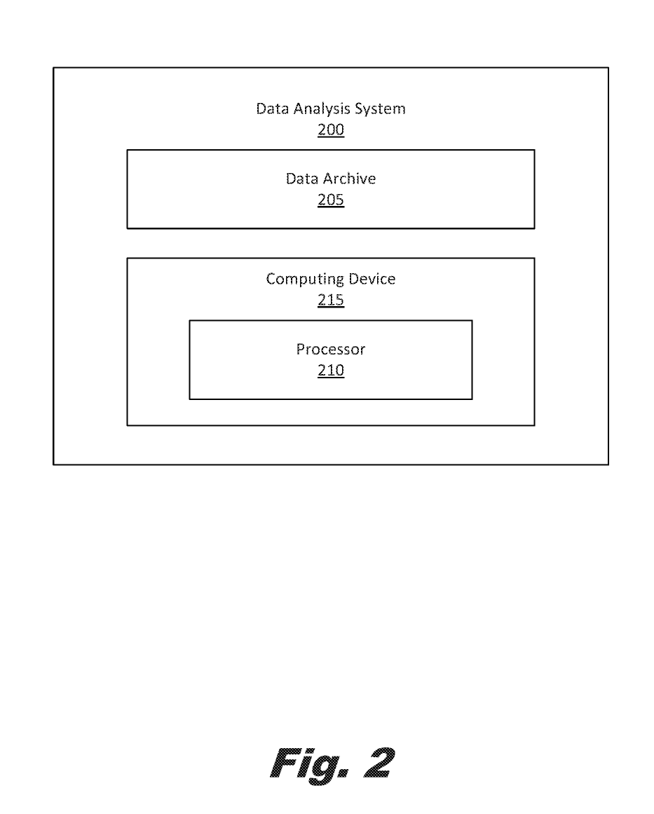

FIG. 2 is a block diagram of a data analysis system (200) according to an example of the principles described herein. The data analysis system (200) may include at least one data archive (205) and at least one computing device (215) including at least one processor (210).

As described herein, the data archive (205) may include a number of compressed files. The archive (205) may, in an example, may include files that have been subjected to the GZIP compression process. This GZIP archive may contain a file manifest provided at a beginning portion of the GZIP file. The archive may be opened using the processor (210) in order to extract the manifest.

To achieve its desired functionality, the data analysis system (200) comprises various computing devices (220) including various hardware components. In an example, the computing device (215) may include hardware components including a processor (210) or processors (210), a number of data storage devices, a number of peripheral device adapters, and a number of network adapters. These hardware components may be interconnected through the use of a number of busses and/or network connections. In one example, the processor (210), data storage device, peripheral device adapters, and a network adapter may be communicatively coupled via a bus.

The processor (210) may include the hardware architecture to retrieve executable code from the data storage device and execute the executable code. The executable code may, when executed by the processor (210), cause the processor (210) to implement at least the functionality of receiving a stream of data, the stream of data comprising ordered compressed files; partitioning the stream of data into portions of the ordered compressed files; concurrently filtering each of the portions of ordered compressed files with a bloom filter; and forward matching portions of the ordered compressed files downstream of the received stream of data according to the methods of the present specification described herein. In the course of executing code, the processor (210) may receive input from and provide output to a number of the remaining hardware units.

The data storage device may store data such as executable program code that is executed by the processor or other processing device. As will be discussed, the data storage device may specifically store computer code representing a number of applications that the processor (210) executes to implement at least the functionality described herein.

The data storage device may include various types of memory modules, including volatile and nonvolatile memory. For example, the data storage device of the present example includes Random Access Memory (RAM), Read Only Memory (ROM), and Hard Disk Drive (HDD) memory. Many other types of memory may also be utilized, and the present specification contemplates the use of many varying type(s) of memory in the data storage device as may suit a particular application of the principles described herein. In certain examples, different types of memory in the data storage device may be used for different data storage needs. For example, in certain examples the processor (210) may boot from Read Only Memory (ROM), maintain nonvolatile storage in the Hard Disk Drive (HDD) memory, and execute program code stored in Random Access Memory (RAM).

Generally, the data storage device may comprise a computer readable medium, a computer readable storage medium, or a non-transitory computer readable medium, among others. For example, the data storage device may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The hardware adapters in the computing device (215) enable the processor (210) to interface with various other hardware elements, external and internal to the data analysis system (200). For example, the peripheral device adapters may provide an interface to input/output devices, such as, for example, display device, a mouse, or a keyboard. The peripheral device adapters may also provide access to other external devices such as an external storage device, a number of network devices such as, for example, servers, switches, and routers, client devices, other types of computing devices, and combinations thereof.

The display device may be provided to allow a user of the data analysis system (200) to interact with and implement the functionality of the data analysis system (200). The peripheral device adapters may also create an interface between the processor (210) and the display device, a printer, or other media output devices. The network adapter may provide an interface to other computing devices within, for example, a network, thereby enabling the transmission of data between the computing device (215) and other devices located within the network.

The data analysis system (200) may, when executed by the processor (210), display the number of graphical user interfaces (GUIs) on the display device associated with the executable program code representing the number of applications stored on the data storage device. Additionally, via making a number of interactive gestures on the GUIs of the display device, a user may actuate certain input devices to select options that cause the processor (210) to receive a stream of data, the stream of data comprising ordered compressed files; partition the stream of data into portions of the ordered compressed files; concurrently filter each of the portions of ordered compressed files with a bloom filter; and forward match portions of the ordered compressed files downstream of the received stream of data. Examples of display devices include a computer screen, a laptop screen, a mobile device screen, a personal digital assistant (PDA) screen, and a tablet screen, among other display devices. Examples of the GUIs displayed on the display device, will be described in more detail below.

The computing device (215) may further comprises a number of modules used in the implementation of the processes and methods described herein. The various modules stored within a computer storage medium the computing device (215) comprise executable program code that may be executed separately. In this example, the various modules may be stored as separate computer program products. In another example, the various modules stored within the computer storage medium of the computing device (215) may be combined within a number of computer program products; each computer program product comprising a number of the modules.

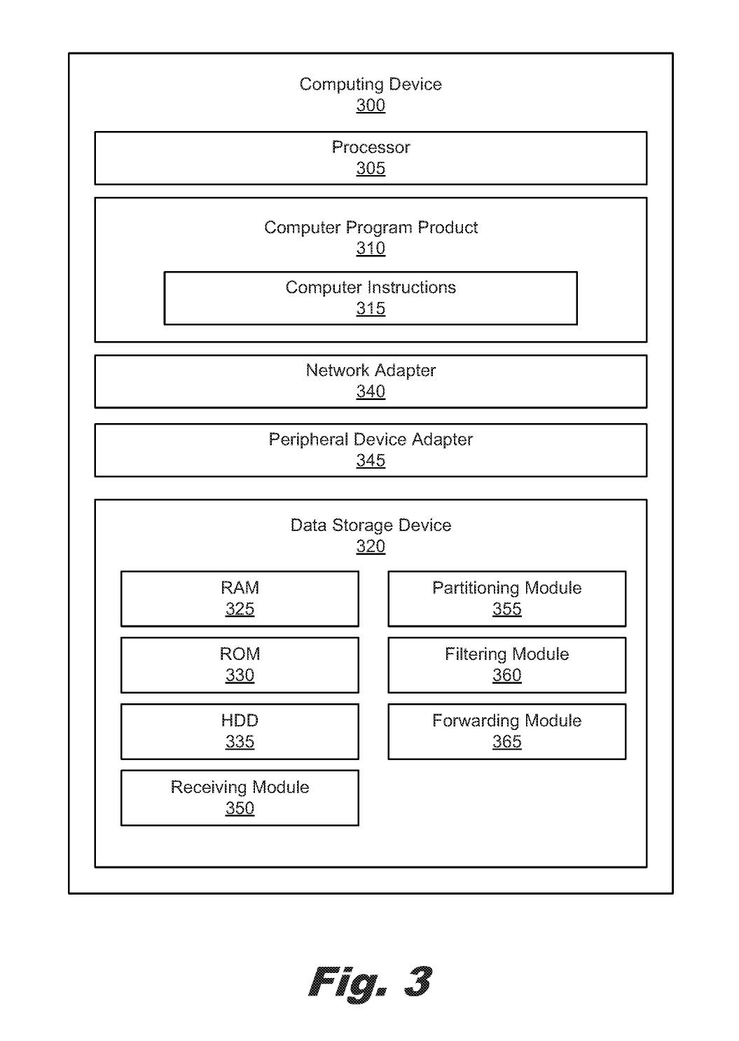

FIG. 3 is a block diagram showing a computing device (300) according to an example of the principles described herein. The computing device (300) may include a processor (305) and a computer program product (310) having computer instructions (315) embodied therewith. As described herein, the computer instructions may be any type of computer readable and/or executable code processed by the processor (305) to, at least, receive a stream of data, the stream of data comprising ordered compressed files; partition the stream of data into portions of the ordered compressed files; concurrently filler each of the portions of ordered compressed files with a bloom filter; and forward match portions of the ordered compressed files downstream of the received stream of data. The computing device (300) may further include a network adapter (340) and a peripheral device adapter (345) as described herein.

The computing device (300) may further include a data storage device (320) that may include any type of storage device such as RAM (325), ROM (330), and/or HDD (335) as described herein. Any one or a plurality of the types of data storage devices (325, 330, 335) may maintain a number of modules (350, 355, 360, 365) thereon. These modules may include, at least, receiving module (350), a partitioning module (355), a filtering module (360), and a forwarding module (365), Each of these modules (350, 355, 360, 365) may be presented in the computing device (300) in a computer readable computer language in order to be executed by the processor (305).

The receiving module (350) may, when executed by the processor (305), receive a stream of data, the stream of data comprising ordered compressed files. As described above, the stream of compressed ordered data may include any data, file, or tuple that is compressed using any type of compression method. In an example, the data may have been compressed previous to receipt (105) using the GZIP compression method which is based on a lossless data compression method such as the DEFLATE method (a combination of a lossless data compression method (i.e., LZ77) and Huffman coding).

The partitioning module (355) may, when executed by the processor (305), partition the stream of data into portions of the ordered compressed files. This partitioning may be based on a logical separation of the stream of compressed and ordered files.

The filtering module (360) may, when executed by the processor (305), filtering each of the portions of ordered compressed files with a filter. In an example, concurrently filtering of each of the portions of ordered compressed files with a bloom filter.

The forwarding module (365) may, when executed by the processor (305), forward matching portions of the ordered compressed files downstream of the received stream of data. In an example, forwarding matching portions of the ordered compressed files downstream of the received stream of data further includes uncompressing any matching portions of the ordered compressed files and applying n uncompressed data filter.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random-access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing, A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/Processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

By way of an example operation of the present methods and systems, the computing device (300) may receive files comprising streaming audio. In this example, a user may convert the speech patterns within the audio into text and conduct a match against a document or set of words. Previous method may have a single dedicated processor that processes each of the utterances in sequence, converting the speech patterns into text, and then matching against the list. During this operation, the files are uncompressed, filtered and/or have computations made on the data, re-compressing the data and/or the result, and passing the filtered data files or result downstream. Instead, the present method and systems allow for a reduction in the text match list to a series of utterances or what the speech to text instances are provided. Additionally, the construction of the bloom filter as described herein may be based on the occurrence of those utterances and may focus on the relation of each of the utterances' occurrence rate relative to the others. The audio in this example may be streamed into a parallel group of speech to text processors that collect the utterances. These utterances will come out of order as each utterance may take a variable amount of time to process. All of the utterances, however, may be ran against the bloom filter allowing, even before a coherent sentence is constructed and the process may determine whether there is a good chance of matching the utterances to any text. Consequently, a relatively large amount of sentencing construction and processing is avoided.

In conclusion, the specification and figures describe a system and method implemented on that system to receive ordered and compressed streaming data. The filtering (via homomorphic compression principles) and computation (via homomorphic encryption principles) allows the partitioning of ordered compressed files and filtering of the files via a bloom filter. This provides for real-time streaming techniques that are relatively faster than otherwise available.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method for data analysis in streaming data comprising:
receiving a stream of data, the stream of data comprising encrypted, ordered, and compressed files;
partitioning the stream of data into portions of the ordered compressed files;
concurrently filtering each of the portions of ordered compressed files with a filter; and
forwarding matching portions of the ordered compressed files downstream of the received stream of data.

2. The method of claim 1, wherein the filter comprises a bloom filter and wherein the method further comprises creating the bloom filter by identifying a type of content within an archive.

3. The method of claim 2, further comprising creating the bloom filter by determining at least one match between the content within the archive and uncompressed data.

4. The method of claim 3, wherein creating the bloom filter further comprises determining an amount of entropy difference between at least one uncompressed file in the archive with a compressed version of the uncompressed file.

5. The method of claim 1, wherein a manifest of each of the ordered compressed files are reviewed to determine the number of items within the ordered compressed files.

6. The method of claim 1, wherein forwarding matching portions of the ordered compressed files downstream of the received stream of data further comprises uncompressing the matching portions of the ordered compressed files and applying an uncompressed data filter.

7. The method of claim 1, wherein the ordered compressed files comprise files compressed using a DEFLATE lossless data compression process.

8. A data analysis system, comprising:
a data archive; and
a computing device including a processor to:
receive a stream of data, the stream of data comprising ordered compressed files;
partition the stream of data into portions of the ordered compressed files;
concurrently filter each of the portions of ordered compressed files with a bloom filter; and
forward match portions of the ordered compressed files downstream of the received stream of data.

9. The system of claim 8, wherein the bloom filter is created by identifying a type of content within an archive.

10. The system of claim 9, wherein the bloom filter is created by determining at least one match between the content within the archive and uncompressed data.

11. The system of claim 10, wherein creation of the bloom filter further comprises determining an amount of entropy difference between at least one uncompressed file in the archive with a compressed version of the uncompressed file.

12. The system of claim 8, wherein the ordered compressed files are deflated prior to concurrently filtering each of the portions of ordered compressed files with a bloom filter.

13. The system of claim 8, wherein forwarding matching portions of the ordered compressed files downstream of the received stream of data further comprises uncompressing the matching portions of the ordered compressed files and applying an uncompressed data filter.

14. The system of claim 8, wherein the ordered compressed files comprise files compressed using a DEFLATE process.

15. A computer program product for analyzing streaming data, the computer program product comprising a computer readable storage medium having program instructions embodied therewith, the program instructions executable by a processor to cause the processor to:
receive a stream of data, the stream of data comprising ordered compressed files;
partition the stream of data into portions of the ordered compressed files;
concurrently filter each of the portions of ordered compressed files with a bloom filter; and
forward match portions of the ordered compressed files downstream of the received stream of data.

16. The computer program product of claim 15, further comprising program instructions executable by a processor to cause the processor to create the bloom filter by identifying a type of content within an archive.

17. The computer program product of claim 15, wherein creating the bloom filter by determining at least one match between the content within the archive and uncompressed data.

18. The computer program product of claim 17, wherein creating the bloom filter further comprises determining an amount of entropy difference between at least one uncompressed file in the archive with a compressed version of the uncompressed file.

19. The computer program product of claim 15, further comprising program instructions executable by a processor to uncompress the matching portions of the ordered compressed files and applying an uncompressed data filter.

20. The computer program product of claim 15, wherein the ordered compressed files comprise files compressed using a DEFLATE process.
